(19) United States
(12) Patent Application Publication
(10) Pub. No.: US 2022/0069414 A1
(43) Pub. Date: Mar. 3, 2022

(54) POROUS LAYER FOR NONAQUEOUS ELECTROLYTE SECONDARY BATTERY

(71) Applicant: Sumitomo Chemical Company, Limited, Tokyo (JP)

(72) Inventors: Kensaku HORIE, Niihama-shi (JP); Hiroki HASHIWAKI, Niihama-shi (JP); Riku MATSUMINE, Niihama-shi (JP); Eri HAYASHI, Niihama-shi (JP); Makoto FURUKAWA, Niihama-shi (JP)

(21) Appl. No.: 17/464,757

(22) Filed: Sep. 2, 2021

(30) Foreign Application Priority Data
Sep. 3, 2020 (JP) 2020-148407
May 27, 2021 (JP) 2021-089535
Sep. 1, 2021 (JP) 2021-142193

(51) Int. Cl. H01M 50/423; H01M 50/417; H01M 50/451

(52) U.S. Cl. CPC H01M 50/423; H01M 50/451; H01M 50/417

(57) ABSTRACT

A nonaqueous electrolyte secondary battery porous layer which has both high-voltage resistance and adhesiveness is provided. The nonaqueous electrolyte secondary battery porous layer contains a resin A, a resin B, and a filler. The resin A has a structure in which a plurality of aromatic rings are connected by chemical bonds, at least some of the chemical bonds being amide bonds, at least some of the chemical bonds being sulfonyl bonds. The resin B is a nitrogen-containing aromatic polymer. The nonaqueous electrolyte secondary battery porous layer contains the resin A in an amount of 20 parts by weight to 80 parts by weight, when a total amount of the resin A and the resin B is regarded as 100 parts by weight.

This Nonprovisional application claims priority under 35 U.S.C. § 119 on Patent Application No. 2020-148407 filed in Japan on Sep. 3, 2020, Patent Application No. 2021-089535 filed in Japan on May 27, 2021, and Patent Application No. 2021-142193 filed in Japan on Sep. 1, 2021, the entire contents of which are hereby incorporated by reference.

### TECHNICAL FIELD

The present invention relates to a porous layer for a nonaqueous electrolyte secondary battery (hereinafter, referred to as a “nonaqueous electrolyte secondary battery porous layer”).

### BACKGROUND ART

Nonaqueous electrolyte secondary batteries, particularly lithium-ion secondary batteries, have high energy densities, and are thus in wide use as batteries for personal computers, mobile telephones, portable information terminals, and the like. Recently, such nonaqueous electrolyte secondary batteries have been developed as batteries for vehicles.

The end-of-charge voltages of conventional nonaqueous electrolyte secondary batteries are approximately 4.1 V to 4.2 V (4.2 V to 4.3 V (vs Li/Li⁺) as voltages relative to the electric potentials of lithium reference electrodes). In contrast, the end-of-charge voltages of recent nonaqueous electrolyte secondary batteries are increased to not less than 4.3 V, which is higher than those of the conventional nonaqueous electrolyte secondary batteries, so that the utilization rates of positive electrodes are increased and thereby the capacities of batteries are increased. For this purpose, it is important that resins contained in nonaqueous electrolyte secondary battery porous layers do not change in quality even when the resins are placed under high-voltage conditions.

Patent Literature 1 is one of documents which disclose resins having such a property. Patent Literature 1 discloses a wholly aromatic polyamide in which aromatic rings located at the respective terminals of its molecular chain each does not have an amino group and in which one or more aromatic rings each have an electron-withdrawing substituent. According to Patent Literature 1, the wholly aromatic polyamide hardly changes in color even when the wholly aromatic polyamide receives a high voltage.

### CITATION LIST

### Patent Literature

[Patent Literature 1]

Japanese Patent Application Publication Tokukai No. 2003-40999

### SUMMARY OF INVENTION

### Technical Problem

One of functional groups each having an electron-withdrawing property is a sulfonyl group. Therefore, it can be expected that employing a resin containing a sulfonyl group allows obtainment of a nonaqueous electrolyte secondary battery porous layer which does not change in quality even under a high-voltage condition. However, as a result of conducting studies, the inventors of the present invention found that a nonaqueous electrolyte secondary battery porous layer which contains (i) a resin containing a sulfonyl group and (ii) a filler is poor in adhesiveness to a polyolefin porous film and peels off in powder form (powder falling occurs).

The object of an aspect of the present invention is to provide a nonaqueous electrolyte secondary battery porous layer which has both high-voltage resistance and adhesiveness.

### Solution to Problem

The inventors of the present invention found that the above object can be attained by a nonaqueous electrolyte secondary battery porous layer which contains a nitrogen-containing aromatic polymer (resin B) in addition to a resin having a sulfonyl group (resin A). Specifically, the present invention encompasses the following features.
<1>

A nonaqueous electrolyte secondary battery porous layer containing:

a resin A;

a resin B; and

a filler,

the resin A having a structure in which a plurality of aromatic rings are connected by chemical bonds,

at least some of the chemical bonds being amide bonds,

at least some of the chemical bonds being sulfonyl bonds,

the resin B being a nitrogen-containing aromatic polymer,

the nonaqueous electrolyte secondary battery porous layer comprising the resin A in an amount of 20 parts by weight to 80 parts by weight, when a total amount of the resin A and the resin B is regarded as 100 parts by weight.
<2>

The nonaqueous electrolyte secondary battery porous layer as described in <1>, wherein 15% to 35% of the chemical bonds are sulfonyl bonds.
<3>

The nonaqueous electrolyte secondary battery porous layer as described in <1> or <2>, wherein the resin A is a wholly aromatic polyamide-based resin containing, as a main component, units each represented by the following Formula (1):

—(NH—Ar¹—NHCO—Ar²—CO)— Formula (1)

wherein

Ar¹ and Ar² may each vary from unit to unit,

Ar¹ and Ar² are each independently a divalent group having one or more aromatic rings, and

not less than 50% of all Ar¹ each have a structure in which two aromatic rings are connected by a sulfonyl bond.
<4>

The nonaqueous electrolyte secondary battery porous layer as described in any one of <1> through <3>, wherein the resin B is para-aramid.
<5>

The nonaqueous electrolyte secondary battery porous layer as described in any of <1> through <4>, wherein the nonaqueous electrolyte secondary battery porous layer satisfies at least one of the following conditions (i) and (ii):

(i) when a weight of the nonaqueous electrolyte secondary battery porous layer is regarded as 100% by weight, the nonaqueous electrolyte secondary battery porous layer comprises the resin A in a proportion of 5% by weight to 50% by weight; and

(ii) when the weight of the nonaqueous electrolyte secondary battery porous layer is regarded as 100% by weight, the nonaqueous electrolyte secondary battery porous layer comprises the filler in a proportion of 20% by weight to 90% by weight.
<6>

The nonaqueous electrolyte secondary battery porous layer as described in any one of <1> through <5>, wherein the filler contains aluminum oxide.
<7>

A nonaqueous electrolyte secondary battery laminated separator comprising:

a polyolefin porous film; and

a nonaqueous electrolyte secondary battery porous layer described in any of <1> through <6>,

the nonaqueous electrolyte secondary battery porous layer being formed on one surface or both surfaces of the polyolefin porous film.
<8>

A nonaqueous electrolyte secondary battery comprising:

a nonaqueous electrolyte secondary battery porous layer described in any of <1> through <6> or a nonaqueous electrolyte secondary battery laminated separator described in <7>.

### Advantageous Effects of Invention

According to an aspect of the present invention, a nonaqueous electrolyte secondary battery porous layer which has both high-voltage resistance and adhesiveness is provided.

### DESCRIPTION OF EMBODIMENTS

The following description will discuss embodiments of the present invention. Note, however, that the present invention is not limited to the embodiments. The present invention is not limited to arrangements described below, but may be altered in various ways by a skilled person within the scope of the claims. The present invention also encompasses, in its technical scope, any embodiment derived by combining technical means disclosed in differing embodiments. Note that a numerical range “A to B” herein means “not less (lower) than A and not more (higher) than B” unless otherwise stated.

[1. Nonaqueous Electrolyte Secondary Battery Porous Layer]

A nonaqueous electrolyte secondary battery porous layer in accordance with an embodiment of the present invention contains a resin A, a resin B, and a filler. Each of these components will be described below.

In this specification, the nonaqueous electrolyte secondary battery porous layer may be abbreviated to “porous layer”. Further, in this specification, a laminated separator for a nonaqueous electrolyte secondary battery (hereinafter referred to as a “nonaqueous electrolyte secondary battery laminated separator”) may be abbreviated to “laminated separator”.

[Resin A]

The resin A has a structure in which a plurality of aromatic rings are connected by chemical bonds. Namely, the resin A has a structure represented by “aromatic ring—chemical bond—aromatic ring—chemical bond—aromatic ring—chemical bond . . . ”. The structure accounts for preferably not less than 80% by weight, more preferably not less than 90% by weight, and still more preferably not less than 95% by weight of the molecule of the resin A. In an embodiment, the molecule of the resin A has the above structure in its entirety.

In this specification, an “aromatic ring” indicates a cyclic compound which satisfies the Hückers rule. Examples of the aromatic ring include benzene, naphthalene, anthracene, azulene, pyrrole, pyridine, furan, and thiophene. In an embodiment, the aromatic ring is composed solely of carbon atoms and hydrogen atoms. In an embodiment, the aromatic ring is a benzene ring or a condensed ring derived from two or more benzene rings (such as naphthalene and anthracene).

In the above structure, at least some of the chemical bonds are amide bonds. In the above structure, at least some of the chemical bonds are sulfonyl bonds. The amide bonds account for preferably 45% to 85% and more preferably 55% to 75% of the chemical bonds. The sulfonyl bonds account for preferably 15% to 35% and more preferably 25% to 35% of the chemical bonds. The amide bonds and the sulfonyl bonds account for, in total, preferably 80% to 100% and more preferably 90% to 100% of the chemical bonds. Note that, in an embodiment, the chemical bonds may be spacer groups. Note also that the spacer groups each contain one or more atoms and do not have a structure in which no atom is contained, such as a single bond.

When the proportion of the amide bonds falls within the above range, the resin A comes to have the properties of an aromatic polyamide. An aromatic polyamide is excellent in heat resistance and the like, and is suitable as a material of a nonaqueous electrolyte secondary battery porous layer. When the proportion of the sulfonyl bonds falls within the above range, the resin A achieves high-voltage resistance derived from the electron-withdrawing property of sulfonyl groups.

The chemical bonds in the above structure may include a bond other than the amide bonds and the sulfonyl bonds. Examples of such a bond include an alkenyl bond (for example, C1-C5 alkenyl bond), an ether bond, an ester bond, an imide bond, and a ketone bond.

In an embodiment, the resin A is a wholly aromatic polyamide-based resin containing, as a main component, units each represented by Formula (1) below. The units each represented by Formula (1) account for preferably not less than 80%, more preferably not less than 90%, and still more preferably not less than 95% of all units contained in the resin A. In an embodiment, the molecule of the resin A is represented by the units each represented by Formula (1), in its entirety, except for the terminals.

—(NH—Ar¹—NHCO—Ar²—CO)— Formula (1)

Ar¹ and Ar² in Formula (1) may each vary from unit to unit. Ar¹ and Ar² are each independently a divalent group having one or more aromatic rings.

Not less than 50% of all Ar¹ each have a structure in which two aromatic rings are connected by a sulfonyl bond. The lower limit of the proportion of Ar¹ having this structure is more preferably not less than 60% and still more preferably not less than 80% of all Ar¹. Examples of —Ar¹— having such a structure include 4,4′-diphenylsulfonyl, 3,4′-diphenylsulfonyl, and 3,3′-diphenylsulfonyl.

Examples of —Ar¹— and —Ar²— each not having the structure in which two aromatic rings are connected by a sulfonyl bond include the following.

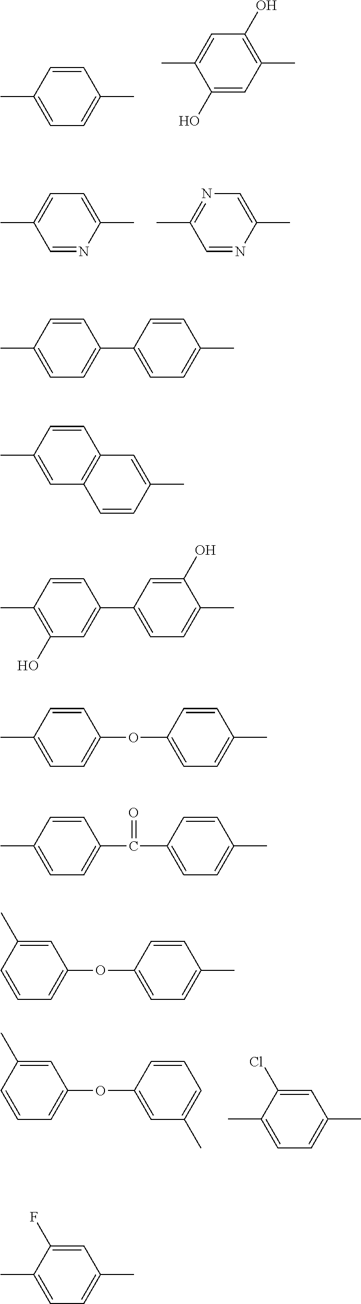

In an embodiment, —Ar¹— having the structure in which two aromatic rings are connected by a sulfonyl bond is 4,4′-diphenylsulfonyl. In an embodiment, —Ar¹— and —Ar²— each not having the structure in which two aromatic rings are connected by a sulfonyl bond is para-phenyl.

In an embodiment, the resin A is an aromatic polyamide having (i) diamine units each derived from 4,4′-diaminodiphenylsulfone and 1,4-paraphenylenediamine and (ii) dicarboxylic acid units each derived from terephthalic acid (or halogenated terephthalic acid). In another embodiment, the resin A is an aromatic polyamide having (i) diamine units each derived from 4,4′-diaminodiphenylsulfone and (ii) dicarboxylic acid units each derived from terephthalic acid (or halogenated terephthalic acid). Monomers contained in these units are readily available, and also these units are easy to handle.

The resin A may have a structure which is not represented by Formula (1). Examples of such a structure include a polyimide backbone.

Each of the above-described resins A may be used alone or two or more of the above-described resins A may be alternatively used in combination.

The resin A can be synthesized according to a conventional method. For example, the resin A having the units each represented by Formula (1) can be synthesized by polymerizing a diamine represented by NH₂—Ar¹—NH₂ and a dicarboxylic halide represented by XOOC—Ar²—COOX (X is a halogen atom such as F, Cl, Br, and I), which serve as monomers, according to a publicly known polymerization method for forming an aromatic polyamide.

[Resin B]

The resin B is a nitrogen-containing aromatic polymer. Examples of the nitrogen-containing aromatic polymer include aromatic polyamides, aromatic polyimides, aromatic polyamide imides, polybenzimidazoles, polyurethanes, and melamine resins. Examples of the aromatic polyamides include wholly aromatic polyamides (aramid resins) and semi-aromatic polyamides. Examples of the aromatic polyamides include para-aramids and meta-aramids. Among the above nitrogen-containing aromatic polymers, wholly aromatic polyamides are preferable, and para-aramids are more preferable.

In this specification, a “para-aramid” indicates a wholly aromatic polyamide in which amide bonds are located at para positions or quasi-para positions of aromatic rings. Note that “quasi-para positions” indicate positions which are located on the opposite sides of an aromatic ring and which are located coaxially or in parallel to each other. Examples of such positions include positions 4 and 4′ of a biphenylene ring, positions 1 and 5 of a naphthalene ring, and positions 2 and 6 of a naphthalene ring.

Specific examples of the para-aramids include poly(paraphenylene terephthalamide), poly(parabenzamide), poly(4,4′ -benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and a paraphenylene terephthalamide/2,6-dichloroparaphenylene terephthalamide copolymer. Among the above para-aramids, poly(paraphenylene terephthalamide) is preferable because poly(paraphenylene terephthalamide) is easy to produce and handle.

Each of the above-described resins B may be used alone or two or more of the above-described resins B may be alternatively used in combination.

The resin B can be synthesized according to a conventional method. For example, the resin B which is an aromatic polyamide can be synthesized by polymerizing a suitable aromatic diamine and a suitable aromatic dicarboxylic halide, which are monomers, according to a publicly known method for forming an aromatic polyamide.

[Filler]

As to the filler, there are the following types of fillers: organic fillers and inorganic fillers.

Examples of the organic fillers include: homopolymers and copolymers which are each obtained from one or more monomers such as styrene, vinyl ketone, acrylonitrile, methyl methacrylate, ethyl methacrylate, glycidyl methacrylate, glycidyl acrylate, and/or methyl acrylate; fluorine-based resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. Each of these organic fillers may be used alone or two or more of these organic fillers may be alternatively used in combination. Among these organic fillers, a polytetrafluoroethylene powder is preferable in terms of chemical stability.

Examples of the inorganic fillers include materials each made of an inorganic matter such as metal oxide, metal nitride, metal carbide, metal hydroxide, carbonate, or sulfate. Specific examples of the inorganic fillers include: powders of aluminum oxide (such as alumina), boehmite, silica, titania, magnesia, barium titanate, aluminum hydroxide, calcium carbonate, and the like; and minerals such as mica, zeolite, kaolin, and talc. Each of these inorganic fillers may be used alone or two or more of these inorganic fillers may be alternatively used in combination. Among these inorganic fillers, aluminum oxide is preferable in terms of chemical stability.

The shape of each of particles of the filler can be a substantially spherical shape, a plate shape, a columnar shape, a needle shape, a whisker shape, a fibrous shape, or the like. The particles can have any shape. The particles preferably have a substantially spherical shape, because such particles facilitate formation of uniform pores.

The average particle diameter of the filler contained in the porous layer is preferably 0.01 μm to 1 μm. In this specification, the “average particle diameter of the filler” indicates a volume-based average particle diameter (D50) of the filler. “D50” means a particle diameter having a value at which a cumulative value reaches 50% in a volume-based particle size distribution. D50 can be measured with use of, for example, a laser diffraction particle size analyzer (product names: SALD2200, SALD2300, etc., manufactured by Shimadzu Corporation).

[Relationship Between Components]

The ratio between the resin A and the resin B contained in the porous layer is set such that, when the total amount of the resin A and the resin B is regarded as 100 parts by weight, the lower limit of the amount of the resin A is not less than 20 parts by weight, preferably not less than 35 parts by weight, and more preferably not less than 50 parts by weight. Further, the ratio between the resin A and the resin B contained in the porous layer is set such that, when the total amount of the resin A and the resin B is regarded as 100 parts by weight, the upper limit of the amount of the resin A is not more than 80 parts by weight, and preferably not more than 75 parts by weight. When the ratio between the resin A and the resin B is set such that the amount of the resin A falls within the above range, the resulting nonaqueous electrolyte secondary battery porous layer has both high-voltage resistance and adhesiveness.

The molecular weight of the resin A is preferably 0.5 dL/g to 5 dL/g, and more preferably 0.6 dL/g to 3 dL/g, when expressed as an intrinsic viscosity. The molecular weight of the resin B is preferably 0.5 dL/g to 5 dL/g, and more preferably 1 dL/g to 3 dL/g, when expressed as an intrinsic viscosity. When the molecular weights of the resin A and the resin B fall within the above respective ranges, a favorable coating property can be achieved, and also the porous layer can have favorable strength.

The proportion of the resin A to the porous layer is preferably 5% by weight to 50% by weight, and more preferably 10% by weight to 40% by weight, when the weight of the porous layer is regarded as 100% by weight. When the proportion of the resin A falls within the above range, it is possible to sufficiently impart, to the porous layer, high-voltage resistance derived from the electron-withdrawing property of the sulfonyl groups contained in the resin A.

The proportion of the filler to the porous layer is preferably 20% by weight to 90% by weight, and more preferably 40% by weight to 80% by weight, when the weight of the porous layer is regarded as 100% by weight. When the proportion of the filler falls within the above range, the resulting porous layer has sufficient ion permeability.

[Other Components]

The porous layer may contain one or more components other than the resin A, the resin B, and the filler. For example, the porous layer may contain a resin other than the resin A and the resin B.

Examples of such a resin include polyolefins; (meth)acrylate-based resins; fluorine-containing resins; polyester-based resins; rubbers; resins each having a melting point or a glass transition temperature of not lower than 180° C.; water-soluble polymers; polycarbonates, polyacetals, and polyether ether ketones.

Preferable examples of the polyolefins include polyethylene, polypropylene, polybutene, and an ethylene-propylene copolymer.

Examples of the fluorine-containing resins include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. The fluorine-containing resins are particularly exemplified by fluorine-containing rubbers each having a glass transition temperature of not higher than 23° C.

Preferable examples of the polyester-based resins include aromatic polyesters, such as polyarylate, and liquid crystal polyesters.

Examples of the rubbers include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the resins each having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Note that, as the resin used for the porous layer, each of these resins may be used alone or two or more of these resins may be alternatively used in combination.

[2. Nonaqueous Electrolyte Secondary Battery Laminated Separator]

An aspect of the present invention is a nonaqueous electrolyte secondary battery laminated separator which includes: a polyolefin porous film; and the above-described porous layer that is formed on one surface or both surfaces of the polyolefin porous film.

[Polyolefin Porous Film]

The nonaqueous electrolyte secondary battery laminated separator in accordance with an embodiment of the present invention includes a polyolefin porous film. The polyolefin porous film has therein many pores connected to one another. This allows a gas and a liquid to pass through the polyolefin porous film from one side to the other side. The polyolefin porous film can be a base material of the nonaqueous electrolyte secondary battery laminated separator. The polyolefin porous film can be one that imparts a shutdown function to the nonaqueous electrolyte secondary battery laminated separator by, when a battery generates heat, melting and thereby making the nonaqueous electrolyte secondary battery laminated separator non-porous.

Note, here, that a “polyolefin porous film” is a porous film which contains a polyolefin-based resin as a main component. Note that the phrase “contains a polyolefin-based resin as a main component” means that the porous film contains the polyolefin-based resin in a proportion of not less than 50% by volume, preferably not less than 90% by volume, and more preferably not less than 95% by volume, relative to the total amount of materials of which the porous film is made.

The polyolefin-based resin which the polyolefin porous film contains as a main component is not limited to any particular one. Examples of the polyolefin-based resin include homopolymers and copolymers which are each a thermoplastic resin and which are each obtained by polymerizing one or more monomers such as ethylene, propylene, 1-butene, 4-methyl-1-pentene, and/or 1-hexene. Specific examples of the homopolymers include polyethylene, polypropylene, and polybutene. Specific examples of the copolymers include an ethylene-propylene copolymer. The polyolefin porous film can be a layer which contains one type of polyolefin-based resin or can be alternatively a layer which contains two or more types of polyolefin-based resins. Among these polyolefin-based resins, polyethylene is more preferable because polyethylene makes it possible to prevent (shut down) a flow of an excessively large electric current at a lower temperature, and high molecular weight polyethylene which contains ethylene as a main component is particularly preferable. Note that the polyolefin porous film can contain a component other than polyolefin, provided that the component does not impair the function of the polyolefin porous film.

Examples of the polyethylene include low-density polyethylene, high-density polyethylene, linear polyethylene (ethylene-α-olefin copolymer), and ultra-high molecular weight polyethylene. Among these polyethylenes, ultra-high molecular weight polyethylene is more preferable, and ultra-high molecular weight polyethylene which contains a high molecular weight component having a weight-average molecular weight of 5×10⁵ to 15×10⁶ is still more preferable. In particular, the polyolefin-based resin which contains a high molecular weight component having a weight-average molecular weight of not less than 1,000,000 is more preferable, because such a polyolefin-based resin allows the polyolefin porous film and the nonaqueous electrolyte secondary battery laminated separator to each have increased strength.

The polyolefin porous film has a thickness of preferably 5 μm to 20 μm. more preferably 7 μm to 15 μm, and still more preferably 9 μm to 15 μm. The polyolefin porous film which has a thickness of not less than 5 μm can sufficiently achieve functions (such as a function of imparting the shutdown function) which the polyolefin porous film is required to have. The polyolefin porous film which has a thickness of not more than 20 μm allows the resulting nonaqueous electrolyte secondary battery laminated separator to be thinner.

The pores in the polyolefin porous film each have a diameter of preferably not more than 0.1 μm, and more preferably not more than not more than 0.06 μm. This makes it possible for the nonaqueous electrolyte secondary battery laminated separator to achieve sufficient ion permeability. Furthermore, this makes it possible to more prevent particles, which constitute an electrode, from entering the polyolefin porous film.

The polyolefin porous film typically has a weight per unit area of preferably 4 g/m² to 20 g/m², and more preferably 5 g/m² to 12 g/m², so as to allow a battery to have a higher weight energy density and a higher volume energy density.

The polyolefin porous film has an air permeability of preferably 30 s/100 mL to 500 s/100 mL, and more preferably 50 s/100 mL to 300 s/100 mL, in terms of Gurley values. This allows the nonaqueous electrolyte secondary battery laminated separator to achieve sufficient ion permeability.

The polyolefin porous film has a porosity of preferably 20% by volume to 80% by volume, and more preferably 30% by volume to 75% by volume. This makes it possible to (i) increase the amount of an electrolyte retained in the polyolefin porous film and (ii) absolutely prevent (shut down) a flow of an excessively large electric current at a lower temperature.

A method of producing the polyolefin porous film is not limited to a particular method, and any publicly known method can be employed. For example, as disclosed in Japanese Patent No. 5476844, a method can be employed which involves adding a filler to a thermoplastic resin, forming a resulting mixture into a film, and then removing the filler.

Specifically, when, for example, the polyolefin porous film is made of the polyolefin-based resin which contains ultra-high molecular weight polyethylene and low molecular weight polyolefin that has a weight-average molecular weight of not more than 10,000, the polyolefin porous film is preferably produced by, from the viewpoint of production costs, a method including the following steps (1) through (4):

(1) kneading 100 parts by weight of ultra-high molecular weight polyethylene, 5 parts by weight to 200 parts by weight of low molecular weight polyolefin which has a weight-average molecular weight of not more than 10,000, and 100 parts by weight to 400 parts by weight of an inorganic filler such as calcium carbonate to obtain a polyolefin-based resin composition;

(2) forming the polyolefin-based resin composition into a sheet;

(3) removing the inorganic filler from the sheet which has been obtained in the step (2); and

(4) stretching the sheet which has been obtained in the step (3).

Alternatively, the polyolefin porous film may be produced by a method disclosed in any of the above-listed Patent Literatures.

The polyolefin porous film can be alternatively a commercially available product which has the above-described characteristics.

[Physical Properties of Nonaqueous Electrolyte Secondary Battery Laminated Separator]

The laminated separator has an air permeability of preferably not more than 500 s/100 mL, and more preferably not more than 300 s/100mL, in terms of Gurley values. The porous layer included in the laminated separator has an air permeability of preferably not more than 400 s/100 mL, and more preferably not more than 200 s/100mL, in terms of Gurley values. When the air permeabilities fall within the above respective ranges, the laminated separator have sufficient ion permeability.

The air permeability of the porous layer is calculated by Y−X, where X represents the air permeability of the polyolefin porous film and Y represents the air permeability of the laminated separator. The air permeability of the porous layer can be adjusted by, for example, adjusting the intrinsic viscosity of one or more of the resins and/or the weight per unit area of the porous layer. Generally, as the intrinsic viscosity of a resin decreases, a Gurley value tends to decrease. As the weight per unit area of a porous layer decreases, a Gurley value tends to decrease.

The porous layer included in the laminated separator has a thickness of preferably not more than 10 μm, more preferably not more than 7 μm, and still more preferably not more than 5 μm.

In addition to the polyolefin porous film and the porous layer, the laminated separator may have another layer as necessary. Examples of such a layer include an adhesive layer and a protective layer.

[Method of Producing Nonaqueous Electrolyte Secondary Battery Laminated Separator]

The porous layer can be formed with use of a coating solution obtained by dissolving or dispersing the resin A, the resin B, the filler, and optionally one or more components in a solvent. Examples of a method of forming the coating solution include a mechanical stirring method, an ultrasonic dispersion method, a high-pressure dispersion method, and a media dispersion method. The solvent can be, for example, N-methylpyrrolidone, N,N-dimethylacetamide, N,N-dimethylformamide, or the like.

A method of forming the porous layer can be, for example, a method which involves preparing the above-described coating solution, applying the coating solution to the polyolefin porous film, and then drying the coating solution so that the porous layer is formed.

As a method of coating the polyolefin porous film with the coating solution, a publicly known coating method, such as a knife coater method, a blade coater method, a bar coater method, a gravure coater method, or a die coater method, can be employed.

The solvent (dispersion medium) is generally removed by a drying method. Examples of the drying method include natural drying, air-blow drying, heat drying, and drying under reduced pressure. Note, however, that any method can be employed, provided that the solvent (dispersion medium) can be sufficiently removed. Note also that drying can be carried out after the solvent (dispersion medium) contained in the coating solution is replaced with another solvent. A method of replacing the solvent (dispersion medium) with another solvent and then removing the another solvent can be specifically as follows: (i) the solvent (dispersion medium) is replaced with a poor solvent having a low boiling point, such as water, alcohol, or acetone, (ii) a solute is deposited, and (iii) drying is carried out.

[3. Nonaqueous Electrolyte Secondary Battery Member and Nonaqueous Electrolyte Secondary Battery]

A member for a nonaqueous electrolyte secondary battery (hereinafter referred to as a “nonaqueous electrolyte secondary battery member”) in accordance with an embodiment of the present invention includes a positive electrode, the above-described nonaqueous electrolyte secondary battery laminated separator, and a negative electrode which are disposed in this order. A nonaqueous electrolyte secondary battery in accordance with an embodiment of the present invention includes the above-described nonaqueous electrolyte secondary battery laminated separator. The nonaqueous electrolyte secondary battery typically has a structure in which a negative electrode and a positive electrode face each other with the nonaqueous electrolyte secondary battery laminated separator sandwiched therebetween. The nonaqueous electrolyte secondary battery is configured such that a battery element, which includes the structure and an electrolyte with which the structure is impregnated, is enclosed in an exterior member. The nonaqueous electrolyte secondary battery is, for example, a lithium ion secondary battery which achieves an electromotive force through doping with and dedoping of lithium ions.

[Positive Electrode]

The positive electrode can be, for example, a positive electrode sheet having a structure in which an active material layer, containing a positive electrode active material and a binding agent, is formed on a positive electrode current collector. The active material layer may further contain an electrically conductive agent.

Examples of the positive electrode active material include materials each capable of being doped with and dedoped of lithium ions.

Examples of the materials include lithium complex oxides each containing at least one type of transition metal such as V, Ti, Cr, Mn, Fe, Co, Ni, and/or Cu. Examples of the lithium complex oxides include lithium complex oxides each having a layer structure, lithium complex oxides each having a spinel structure, and solid solution lithium-containing transition metal oxides each constituted by a lithium complex oxide having both a layer structure and a spinel structure. Examples of the lithium complex oxides also include lithium cobalt complex oxides and lithium nickel complex oxides. Further, examples of the lithium complex oxides also include lithium complex oxides each obtained by substituting one or more of transition metal atoms, which constitute a large part of any of the above lithium complex oxides, with another or other elements such as Na, K, B, F, Al, Ti, V, Cr, Mn, Fe, Co, Ni, Cu, Zn, Mg, Ca, Ga, Zr, Si, Nb, Mo, Sn, and/or W.

Examples of the lithium complex oxides each obtained by substituting one or more of transition metal atoms, which constitute a large part of any of the above lithium complex oxides, with another or other elements include: lithium cobalt complex oxides each having a layer structure and each represented by Formula (2) below; lithium nickel complex oxides each represented by Formula (3) below; lithium-manganese complex oxides each having a spinel structure and each represented by Formula (4) below; and solid solution lithium-containing transition metal oxides each represented by Formula (5) below.

Li[Liₓ(Co₁₋ₐM¹ₐ)₁₋ₓ]O₂ (2)

where: M¹ is at least one type of metal selected from the group consisting of Na, K, B, F, Al, Ti, V, Cr, Mn, Fe, Ni, Cu, Zn, Mg, Ga, Zr, Si, Nb, Mo, Sn, and W; and −0.1≤x≤0.30 and 0≤a≤0.5 are satisfied.

Li[Li_{y}(Ni_{1-b}M²_{b})_{1-y}]O₂ (3)

where: M² is at least one type of metal selected from the group consisting of Na, K, B, F, Al, Ti, V, Cr, Mn, Fe, Co, Cu, Zn, Mg, Ga, Zr, Si, Nb, Mo, Sn, and W; and −0.1≤y≤0.30 and 0≤b≤0.5 are satisfied.

Li_{z}Mn_{2-c}M³_{c}O₄ (4)

where: M³ is at least one type of metal selected from the group consisting of Na, K, B, F, Al, Ti, V, Cr, Fe, Co, Ni, Cu, Zn, Mg, Ga, Zr, Si, Nb, Mo, Sn, and W; and 0.9≤z≤and 0≤c≤1.5 are satisfied.

Li_{1+w}M⁴_{d}M⁵ₑO₂ (5)

where: M⁴ and M⁵ are each independently at least one type of metal selected from the group consisting of Al, Ti, V, Cr, Mn, Fe, Co, Ni, Cu, Zn, Mg, and Ca; and 0<w≤1/3, 0≤d≤2/3, 0≤e≤2/3,and w+d+e=1 are satisfied.

Specific examples of the lithium complex oxides represented by Formulae (2) to (5) include LiCoO₂, LiNiO₂, LiMnO₂, LiNi_{0.8}Co_{0.2}O₂, LiNi_{0.5}Mn_{0.5}O₂, LiNi_{0.85}Co_{0.10}Al_{0.05}O₂, LiNi_{0.8}Co_{0.15}Al_{0.05}O₂, LiNi_{0.5}Co_{0.2}Mn_{0.3}O₂, LiNi_{0.6}Co_{0.2}Mn_{0.2}O₂, LiNi_{0.33}Co_{0.33}Mn_{0.33}O₂, LiMn₂O₄, LiMn_{1.5}Ni_{0.5}O₄, LiMn_{1.5}Fe_{0.5}O₄, LiCoMnO₄, Li_{1.21}Ni_{0.20}Mn_{0.59}O₂, Li_{1.22}Ni_{0.20}Mn_{0.58}O₂, Li_{1.22}Ni_{0.15}Co_{0.10}Mn_{0.53}O₂, Li_{1.07}Ni_{0.35}Co_{0.08}Mn_{0.50}O₂, and Li_{1.07}Ni_{0.36}Co_{0.08}Mn_{0.49}O₂.

Lithium complex oxides other than the lithium complex oxides represented by Formulae (2) to (5) can be also preferably used as the positive electrode active material. Examples of such lithium complex oxides include LiNiVO₄, LiV₃O₆, and Li_{1.2}Fe_{0.4}Mn_{0.4}O₂.

Examples of a material which can be preferably used as the positive electrode active material, other than the lithium complex oxides, include phosphates each having an olivine structure. Specific examples of such phosphates include phosphates each having an olivine structure and each represented by the following Formula (6).

Liᵥ(M⁶_{f}M⁷_{g}M⁸ₕM⁹ᵢ)ⱼPO₄ (6)

where: M⁶ is Mn, Co, or Ni; M⁷ is Ti, V, Cr, Mn, Fe, Co, Ni, Zr, Nb, or Mo; M⁸ is a transition metal, optionally excluding the elements in the groups VIA and VIIA, or a representative element; M⁹ is a transition metal, optionally excluding the elements in the groups VIA and VIIA, or a representative element; and 1.2≤a≤0.9, 1≤b≤0.6, 0.4≤c≤0, 0.2≤d≤0, 0.2≤e≤0, and 1.2≤f≤0.9 are satisfied.

When the positive electrode active material is a lithium-metal complex oxide, each of particles of the lithium-metal complex oxide preferably has a coating layer on a surface thereof. Examples of a material of which the coating layer is made include metal complex oxides, metal salts, boron-containing compounds, nitrogen-containing compounds, silicon-containing compounds, sulfur-containing compounds. Among these materials, metal complex oxides are suitably used.

The metal complex oxides are preferably oxides each having lithium ion conductivity. Examples of such metal complex oxides include metal complex oxides of Li and at least one type of element selected from the group consisting of Nb, Ge, Si, P, Al, W, Ta, Ti, S, Zr, Zn, V, and B. When the positive electrode active material is a material particles of which each have a coating layer, the coating layer suppresses a side reaction which occurs at the interface between the positive electrode active material and the electrolyte at high voltages, and the resulting secondary battery can achieve a longer life. Moreover, the coating layer suppresses formation of a high-resistance layer at the interface between the positive electrode active material and the electrolyte, and the resulting secondary battery can achieve high output.

Examples of the electrically conductive agent include carbonaceous materials such as natural graphite, artificial graphite, cokes, carbon black, pyrolytic carbons, carbon fibers, and fired products of organic polymer compounds.

Examples of the binding agent include: thermoplastic resins such as polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, thermoplastic polyimide, polyethylene, and polypropylene; acrylic resins; and styrene-butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet include: a method which involves pressure-molding, on the positive electrode current collector, the positive electrode active material, the electrically conductive agent, and the binding agent which constitute a positive electrode mix; and a method which involves (i) forming, into a paste, the positive electrode active material, the electrically conductive agent, and the binding agent with use of an appropriate organic solvent to obtain the positive electrode mix, (ii) coating the positive electrode current collector with the positive electrode mix, (iii) drying the positive electrode mix, and then (iv) pressuring the resulting sheet-shaped positive electrode mix on the positive electrode current collector so that the sheet-shaped positive electrode mix is firmly fixed to the positive electrode current collector.

[Negative Electrode]

The negative electrode can be, for example, a negative electrode sheet having a structure in which an active material layer, containing a negative electrode active material and a binding agent, is formed on a negative electrode current collector. The active material layer may further contain an electrically conductive agent.

Examples of the negative electrode active material include carbon materials, chalcogen compounds (such as oxides and sulfides), nitrides, metals, and alloys each of which is capable of being doped with and dedoped of lithium ions at electric potentials lower than that of the positive electrode.

Examples of the carbon materials which can be used as the negative electrode active material include graphites such as natural graphite and artificial graphite, cokes, carbon black, pyrolytic carbons, carbon fibers, and fired products of organic polymer compounds.

Examples of the oxides which can be used as the negative electrode active material include: oxides of silicon which are represented by a formula SiOₓ (where x is a positive real number), such as SiO₂ and SiO; oxides of titanium which are represented by a formula TiO (where x is a positive real number), such as TiO₂ and TiO; oxides of vanadium which are represented by a formula VₓO_{y} (where x and y are each a positive real number), such as V₂O₅ and VO₂; oxides of iron which are represented by a formula FeₓO_{y} (where x and y are each a positive real number), such as Fe₃O₄, Fe₂O₃, and FeO; oxides of tin which are represented by a formula SnO (where x is a positive real number) such as SnO₂ and SnO; oxides of tungsten which are represented by a general formula WOₓ (where x is a positive real number) such as WO₃ and WO₂; and complex metal oxides each of which contains lithium and titanium or vanadium, such as Li₄Ti₅O₁₂ and LiVO₂.

Examples of the sulfides which can be used as the negative electrode active material include: sulfides of titanium which are represented by a formula TiₓS_{y} (where x and y are each a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeₓS_{y} (where x and y are each a positive real number), such as Fe₃S₄, FeS₂, and FeS; sulfides of molybdenum which are represented by a formula MoₓS_{y} (where x and y are each a positive real number), such as Mo₂S₃ and MoS₂; sulfides of tin which are represented by a formula SnS (where x is a positive real number) such as SnS₂ and SnS; sulfides of tungsten which are represented by a formula WSₓ (where x is a positive real number), such as WS₂; sulfides of antimony which are represented by a formula SbₓS_{y} (where x and y are each a positive real number), such as Sb₂S₃; and sulfides of selenium which are represented by a formula SeₓS_{y} (where x and y are each a positive real number), such as Se₅S₃, SeS₂, and SeS.

Examples of the nitrides which can be used as the negative electrode active material include lithium-containing nitrides such as Li₃N and Li₃₋ₓAₓN (where A is one or both of Ni and Co, and 0<x<3 is satisfied).

Each of these carbon materials, oxides, sulfides, and nitrides may be used alone or two or more of these carbon materials, oxides, sulfides, and nitrides may be used in combination. These carbon materials, oxides, sulfides, and nitrides can be each crystalline or amorphous. One or more of these carbon materials, oxides, sulfides, and nitrides are mainly supported by the negative electrode current collector, and the resulting negative electrode current collector is used as an electrode.

Examples of the metals which can be used as the negative electrode active material include lithium metals, silicon metals, and tin metals.

It is also possible to use a complex material which contains Si or Sn as a first constituent element and also contains second and/or third constituent elements. The second constituent element is, for example, at least one type of element selected from cobalt, iron, magnesium, titanium, vanadium, chromium, manganese, nickel, copper, zinc, gallium, and zirconium. The third constituent element is, for example, at least one type of element selected from boron, carbon, aluminum, and phosphorus.

In particular, since a high battery capacity and excellent battery characteristics are achieved, the above metal material is preferably a simple substance of silicon or tin (which may contain a slight amount of impurities), SiOᵥ (0<v≤2), SnO_{w} (0≤w≤2), an Si—Co—C complex material, an Si—Ni—C complex material, an Sn—Co—C complex material, or an Sn—Ni—C complex material.

Examples of the negative electrode current collector include Cu, Ni, and stainless steel. Among these materials, Cu is more preferable because Cu is not easily alloyed with lithium particularly in a lithium-ion secondary battery and is easily processed into a thin film.

Examples of a method of producing the negative electrode sheet include: a method which involves pressure-molding, on the negative electrode current collector, the negative electrode active material which constitutes a negative electrode mix; and a method which involves (i) forming the negative electrode active material into a paste with use of an appropriate organic solvent to obtain the negative electrode mix, (ii) coating the negative electrode current collector with the negative electrode mix, (iii) drying the negative electrode mix, and then (iv) pressing the resulting sheet-shaped negative electrode mix on the negative electrode current collector so that the sheet-shaped negative electrode mix is firmly fixed to the negative electrode current collector. The paste preferably contains an electrically conductive agent as described above and a binding agent as described above.

[Nonaqueous Electrolyte]

The nonaqueous electrolyte can be, for example, a nonaqueous electrolyte obtained by dissolving a lithium salt in an organic solvent. Examples of the lithium salt include LiClO₄, LiPF₆, LiAsF₆, LiSbF₆, LiBF₄, LiSO₃F, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (BOB refers to bis(oxalato)borate), lower aliphatic carboxylic acid lithium salt, and LiAlCl₄. Each of these lithium salts may be used alone or two or more of these lithium salts may be used as a mixture. Among these lithium salts, it is preferable to use at least one fluorine-containing lithium salt selected from the group consisting of LiPF₆, LiAsF₆, LiSbF₆, LiBF₄, LiSO₃F, LiCF₃SO₃, LiN(SO₂CF₃)₂, and LiC(SO₂CF₃)₃.

Examples of the organic solvent include carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and compounds each prepared by introducing a fluoro group into any of these organic solvents (i.e., compounds each prepared by substituting one or more hydrogen atoms of any of these organic solvents with one or more respective fluorine atoms).

The organic solvent is preferably a mixed solvent obtained by mixing two or more of the above organic solvents. Particularly, the organic solvent is preferably a mixed solvent containing a carbonate, still more preferably a mixed solvent containing a cyclic carbonate and an acyclic carbonate or a mixed solvent containing a cyclic carbonate and an ether. The mixed solvent containing a cyclic carbonate and an acyclic carbonate is preferably a mixed solvent containing ethylene carbonate, dimethyl carbonate, and ethyl methyl carbonate. The nonaqueous electrolyte which contains such a mixed solvent has advantages of having a wider operating temperature range, being less prone to deterioration even when used at a high voltage, being less prone to deterioration even when used for a long period of time, and less prone to decomposition even when the negative electrode active material is a graphite material such as natural graphite or artificial graphite.

It is preferable to use, as the nonaqueous electrolyte, a nonaqueous electrolyte containing (i) a lithium salt containing fluorine (such as LiPF₆) and (ii) an organic solvent containing a fluorine substituent, because such a nonaqueous electrolyte allows the resulting nonaqueous electrolyte secondary battery to have increased safety. It is further preferable to use a mixed solvent containing a dimethyl carbonate and an ether having a fluorine substituent (such as pentafluoropropyl methylether or 2,2,3,3-tetrafluoropropyl difluoro methylether), because such a mixed solvent allows the resulting nonaqueous electrolyte secondary battery to have a high capacity maintenance ratio even when the nonaqueous electrolyte secondary battery is discharged at a high voltage.

[Method of Producing Nonaqueous Electrolyte Secondary Battery Member and Method of Producing Nonaqueous Electrolyte Secondary Battery]

A method of producing the nonaqueous electrolyte secondary battery member can be, for example, a method which involves disposing the positive electrode, the above-described nonaqueous electrolyte secondary battery laminated separator, and the negative electrode in this order.

A method of producing the nonaqueous electrolyte secondary battery can be, for example, the following method. First, the nonaqueous electrolyte secondary battery member is placed in a container which is to be a housing of the nonaqueous electrolyte secondary battery. Next, the container is filled with the nonaqueous electrolyte, and then the container is hermetically sealed while pressure inside the container is reduced. In this manner, it is possible to produce the nonaqueous electrolyte secondary battery.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in more detail with reference to Examples and Comparative Examples. Note, however, that the present invention is not limited to such Examples and Comparative Examples.

[Methods of Measuring Various Physical Properties]

In Examples and Comparative Examples below, physical properties were measured by methods below.

(1) Intrinsic Viscosity

A solution was prepared by dissolving 0.5 g of a polymer, the intrinsic viscosity of which was to be measured, in 100 mL of 96% to 98% sulfuric acid. Subsequently, a period of time which the solution took to flow at 30° C. and a period of time which 96% to 98% sulfuric acid took to flow were measured with use of a capillary viscometer. The intrinsic viscosity was calculated by the following expression with use of the measured periods of time.

Intrinsic viscosity=ln(T/T0)/C [unit: dL/g]
where:
T represents the period of time which the sulfuric acid solution containing the polymer took to flow;
T0 represents the period of time which the sulfuric acid took to flow; and
C represents the concentration of the polymer in the solution (dL/g).

(2) High-Voltage Resistance

A test battery was prepared which included a nonaqueous electrolyte secondary battery laminated separator prepared in each of Examples and Comparative Examples. The test battery was subjected to a trickle charge test under a high-voltage condition. After the test, the test battery was disassembled, and the color of a portion of a nonaqueous electrolyte secondary battery porous layer which part had been in contact with a positive electrode active material layer was visually checked. Evaluation was made in accordance with the following criteria.
Pass: the porous layer was colorless. Namely, even when the trickle charge test was conducted under the high-voltage condition, oxidization of resins was prevented.
Fail: the porous layer changed in color to brown. Namely, the resins were oxidized due to the trickle charge test under the high-voltage condition.

A specific procedure of the test was as follows.
1. A positive electrode and a negative electrode were prepared. The positive electrode was an electrode hoop which had been purchased from Hassan Co., Ltd and which had a thickness of 58 μm and a density of 2.5 g/cm³. The composition of a positive electrode active material was such that the amount of LiNi_{0.5}Co_{0.2}Mn_{0.3}O₂ was 92 parts by weight, the amount of an electrically conductive material was 5 parts by weight, and the amount of a binding agent was 3 parts by weight. The negative electrode was an electrode hoop which had been purchased from Hassan Co., Ltd and which had a thickness of 48 μm and a density of 1.5 g/cm³. The composition of a negative electrode active material was such that the amount of natural graphite was 98 parts by weight, the amount of a binding agent was 1 part by weight, and the amount of carboxymethyl cellulose was 1 part by weight.
2. A nonaqueous electrolyte secondary battery member was produced. The positive electrode, the laminated separator, and the negative electrode were disposed in this order in a laminate pouch. In so doing, the laminated separator was disposed such that (i) the porous layer of the laminated separator and a positive electrode active material layer of the positive electrode were in contact with each other and (ii) a polyethylene porous film of the laminated separator and a negative electrode active material layer of the negative electrode were in contact with each other.
3. The nonaqueous electrolyte secondary battery member was stored in a bag which was made up of an aluminum layer and a heat-sealing layer that was formed on the aluminum layer, and 230 μL of a nonaqueous electrolyte was injected into the bag. The nonaqueous electrolyte was one that had been prepared by dissolving LiPF₆ at a concentration of 1 mol/L in a mixed solvent obtained by mixing ethylene carbonate, ethyl methyl carbonate, and diethyl carbonate at a ratio of 3:5:2 (volume ratio).
4. The bag was heat-sealed while pressure inside the bag was reduced. A test battery was thus produced.
5. The test battery was charged with a constant electric current with use of a charge-discharge test apparatus manufactured by Toyo System Co., Ltd. The test battery was charged with a constant electric current under the following conditions: a temperature was set to 25° C., an electric current was set to 1 C, and a final voltage was set to 4.5 V (i.e., 4.6 V (vs Li/Li⁺)).
6. The test battery was trickle-charged with use of a charge-discharge test apparatus manufactured by Toyo System Co., Ltd. The test battery was trickle-charged under the following conditions: a temperature was set to 25° C., a voltage was set to 4.5 V (i.e., 4.6 V (vs Li/Li⁺)), and a period of time was set to 168 hours.
7. After the trickle charging was finished, the test battery was disassembled, and the laminated separator was taken out. The color of a surface of the porous layer was visually observed.

(3) Adhesiveness

A surface of the porous layer of the laminated separator produced in each of Examples and Comparative Examples was visually checked to evaluate adhesiveness. Evaluation was made in accordance with the following criteria.
Pass: Peeling-off of the porous layer was not seen. Namely, adhesiveness between the polyolefin porous film and the porous layer was high.
Fail: Peeling-off in scales of the porous layer was seen. Namely, adhesiveness between the polyolefin porous film and the porous layer was low.

### Synthesis Example

### Synthesis Example 1

### Synthesis of Resin A

A resin A (poly(4,4′-diphenylsulfonyl terephthalamide)) was synthesized by the following procedure.
1. A 0.5-L separable flask having a stirring blade, a thermometer, a nitrogen incurrent canal, and a powder addition port was sufficiently dried.
2. 420 g of N-methylpyrrolidone was introduced into the flask. Further, 27.27 g of calcium chloride (which had been dried at 200° C. for 2 hours) was added, and a resulting mixture was heated to 100° C.
3. After the calcium chloride completely dissolved, 30.77 g of 4,4′-diaminodiphenylsulfone was added at 100° C., and then a resulting mixture was completely dissolved.
4. A resulting solution was cooled to room temperature. While the temperature of the solution was maintained at 25±2° C., 24.87 g in total of terephthalic acid dichloride was added in 3 separate portions.
5. While the temperature of a resulting solution was maintained at 25±2° C., the solution was matured for 1 hour to obtain the solution which contained a resin A.

Part of the solution which contained the resin A was collected, and a sample of the resin A was deposited by water. Measurement was carried out with use of the sample, and it was found that the intrinsic viscosity of the resin A was 0.94 dL/g.

### Synthesis Example 2

### Synthesis of Resin B

A resin B (poly(paraphenylene terephthalamide)) was synthesized by the following procedure.
1. A 0.5-L separable flask having a stirring blade, a thermometer, a nitrogen incurrent canal, and a powder addition port was sufficiently dried.
2. 420 g of N-methylpyrrolidone was introduced into the flask. Further, 27.27 g of calcium chloride (which had been dried at 200° C. for 2 hours) was added, and a resulting mixture was heated to 100° C.
3. After the calcium chloride completely dissolved, the temperature of a resulting solution was returned to room temperature. Subsequently, 13.29 g of 1,4-paraphenylenediamine was added and completely dissolved.
4. While the temperature of a resulting solution was maintained at 20±2° C., 24.33 g in total of terephthalic acid dichloride was added in 3 separate portions.
5. While the temperature of a resulting solution was maintained at 20±2° C., the solution was matured for 1 hour to obtain the solution which contained a resin B.

Part of the solution which contained the resin B was collected, and a sample of the resin B was deposited by water. Measurement was carried out with use of the sample, and it was found that the intrinsic viscosity of the resin B was 1.90 dL/g.

### Example 1

A porous layer which contained the resin A and the resin B at a weight ratio of 50:50 was produced. Specifically, the polymer solutions synthesized in Synthesis Examples 1 and 2 were mixed so that the weight ratio between the resin A and the resin B was 50:50. With respect to 100 parts by weight of the resins which were contained in this mixed liquid, 100 parts by weight of aluminum oxide (average particle diameter: 0.013 μm) was added. A resulting mixture was diluted with NMP, and uniformly dispersed with use of a pressure type disperser to obtain a coating solution (1). The solid content concentration of the coating solution (1) was 10% by weight.

The coating solution (1) was applied to a polyethylene porous film (thickness: 10 μm, air permeability: 150 s/100 mL), and the polyethylene porous film to which the coating solution (1) was applied was treated in an oven at 50° C. and a humidity of 70% for 2 minutes so that a porous layer (1) was deposited. Thereafter, the resulting polyethylene porous film was washed with water and dried to obtain a laminated separator including the porous layer (1). The laminated separator including the porous layer (1) had a thickness of 13 μm and an air permeability of 260 s/100 mL.

### Example 2

A coating solution (2) and a porous layer (2) were obtained by a procedure similar to that in Example 1, except that the weight ratio between the resin A and the resin B was set to 75:25. A laminated separator including the porous layer (2) had a thickness of 13 μm and an air permeability of 210 s/100 mL.

### Comparative Example 1

A porous layer which contained the resin A and the resin B at a weight ratio of 100:0 was produced. Specifically, 100 parts by weight of aluminum oxide (average particle diameter: 0.013 μm) was added to the polymer solution synthesized in Synthesis Example 1, with respect to 100 parts by weight of the resin contained in the polymer solution. A resulting mixture was diluted with NMP, and uniformly dispersed with use of a pressure type disperser to obtain a comparative coating solution (1). The solid content concentration of the comparative coating solution (1) was 10% by weight.

A comparative porous layer (1) was formed from the comparative coating solution (1) by a procedure similar to that in Example 1. In this manner, a laminated separator including the comparative porous layer (1) was obtained. It was not possible to stably measure the thickness and the air permeability of the laminated separator including the comparative porous layer (1), because the porous layer peeled off in scales.

### Comparative Example 2

A comparative coating solution (2) and a comparative porous layer (2) were obtained by a procedure similar to that in Example 1, except that the weight ratio between the resin A and the resin B was set to 90:10. It was not possible to stably measure the thickness and the air permeability of a laminated separator including the comparative porous layer (2), because the porous layer peeled off in scales.

(Results)

Table 1 shows results of evaluating the high-voltage resistance and the adhesiveness of the porous layers produced in Examples and Comparative Examples.

TABLE 1

| | Resin A: | High-voltage | |
|---|---|---|---|
| | Resin B | resistance | Adhesiveness |
| Example 1 | 50:50 | Pass | Pass |
| Example 2 | 75:25 | Pass | Pass |
| Comparative | 100:0 | N.A. | Fail |
| Example 1 | | | |
| Comparative | 90:10 | N.A. | Fail |
| Example 2 | | | |

As shown in Table 1, since the porous layers produced in Examples each contained the resin A containing sulfonyl groups, they each exhibited favorable high-voltage resistance. However, since the porous layers produced in Comparative Examples 1 and 2 each contained the resin B in a small amount, they had insufficient adhesiveness, and thus it was not possible to assemble batteries with use of them. Therefore, the high-voltage resistance of the porous layers produced in Comparative Examples was not evaluated.

Incidentally, it is considered that when the amount of the resin A contained in a porous layer decreases, the number of the sulfonyl groups, which are each an electron-withdrawing group, also decreases. Therefore, it is considered that when the amount of the resin A is small (less than the resin A:the resin B=20:80), the resulting porous layer has poor high-voltage resistance.

### Reference Example

The polymerization solution obtained in Synthesis Example 1 was applied to a polyethylene porous film (thickness: 10 μm, air permeability: 150 s/100 mL) as a coating solution, and the polyethylene porous film to which the polymerization solution was applied was treated in an oven at 50° C. and a humidity of 70% for 2 minutes so that a reference porous layer (1) was formed. Thereafter, the resulting polyethylene porous film was washed with water and dried to obtain a laminated separator including the reference porous layer (1). A surface of the reference porous layer (1) was visually observed, and peeling-off of the porous layer was not seen. From this fact, it is suggested that a problem which relates to the adhesiveness of a porous layer and which is to be solved by an aspect of the present invention does not occur when only a resin having a sulfonyl group is used, but occurs when a resin having a sulfonyl group and a filler are used.

### INDUSTRIAL APPLICABILITY

The present invention is applicable to, for example, a nonaqueous electrolyte secondary battery.

1. A nonaqueous electrolyte secondary battery porous layer comprising:
a resin A;
a resin B; and
a filler,
the resin A having a structure in which a plurality of aromatic rings are connected by chemical bonds,
at least some of the chemical bonds being amide bonds,
at least some of the chemical bonds being sulfonyl bonds,
the resin B being a nitrogen-containing aromatic polymer,
the nonaqueous electrolyte secondary battery porous layer comprising the resin A in an amount of 20 parts by weight to 80 parts by weight, when a total amount of the resin A and the resin B is regarded as 100 parts by weight.

2. The nonaqueous electrolyte secondary battery porous layer as set forth in claim 1, wherein 15% to 35% of the chemical bonds are sulfonyl bonds.

3. The nonaqueous electrolyte secondary battery porous layer as set forth in claim 1, wherein the resin A is a wholly aromatic polyamide-based resin containing, as a main component, units each represented by the following Formula (1):
—(NH—Ar¹—NHCO—Ar²—CO)— Formula (1)
wherein
Ar¹ and Ar² may each vary from unit to unit,
Ar¹ and Ar² are each independently a divalent group having one or more aromatic rings, and
not less than 50% of all Ar¹ each have a structure in which two aromatic rings are connected by a sulfonyl bond.

4. The nonaqueous electrolyte secondary battery porous layer as set forth in claim 1, wherein the resin B is para-aramid.

5. The nonaqueous electrolyte secondary battery porous layer as set forth in claim 1, wherein the nonaqueous electrolyte secondary battery porous layer satisfies at least one of the following conditions (i) and (ii):
(i) when a weight of the nonaqueous electrolyte secondary battery porous layer is regarded as 100% by weight, the nonaqueous electrolyte secondary battery porous layer comprises the resin A in a proportion of 5% by weight to 50% by weight; and
(ii) when the weight of the nonaqueous electrolyte secondary battery porous layer is regarded as 100% by weight, the nonaqueous electrolyte secondary battery porous layer comprises the filler in a proportion of 20% by weight to 90% by weight.

6. The nonaqueous electrolyte secondary battery porous layer as set forth in claim 1, wherein the filler contains aluminum oxide.

7. A nonaqueous electrolyte secondary battery laminated separator comprising:
a polyolefin porous film; and
a nonaqueous electrolyte secondary battery porous layer recited in claim 1,
the nonaqueous electrolyte secondary battery porous layer being formed on one surface or both surfaces of the polyolefin porous film.

8. A nonaqueous electrolyte secondary battery comprising:
a nonaqueous electrolyte secondary battery porous layer recited in claim 1.

9. A nonaqueous electrolyte secondary battery comprising:
a nonaqueous electrolyte secondary battery laminated separator recited in claim 7.
